(19) United States
(12) Patent Application Publication
(10) Pub. No.: US 2026/0260437 A1
(43) Pub. Date: Sep. 3, 2026

(54) AUGMENTED REALITY INTERFACE FOR EXPERIENCE PLATFORM

(71) Applicant: TAIT GLOBAL LLC, Lititz, PA (US)

(72) Inventors: James D. LOVE, Lititz, PA (US); Hugo BOUJUT-BURGUN, Blainville (CA)

(21) Appl. No.: 19/552,878

(22) Filed: Feb. 27, 2026

Related U.S. Application Data
(60) Provisional application No. 63/765,119, filed on Feb. 28, 2025.

(51) Int. Cl. G06T 19/00; G02B 27/01

(52) U.S. Cl. CPC G06T 19/006; G02B 27/017

(57) ABSTRACT

An experience platform system having a physical world element. The physical world element includes an augmented reality interface system. The experience platform system also includes a virtual world element, and an experience controller integrating the physical world element and the virtual world element. The integrating includes real-time control of one or both of the physical world element and the virtual world element.

### RELATED APPLICATIONS

This application claims priority to U.S. Provisional Patent Application 63/765,119, filed February 28, 2025, entitled, "AUGMENTED REALITY INTERFACE FOR EXPERIENCE PLATFORM", which is incorporated by reference herein in its entirety. FIELD OF THE INVENTION

### FIELD OF THE INVENTION

The present disclosure is generally directed to a virtual and physical experience platform utilizing an augmented reality interface.

### BACKGROUND OF THE INVENTION

In recent years consumers have been increasing their preferences for customized/personalized experiences when they visit entertainment venues, live entertainment events, transportation venues, such as airports or train stations, or other public spaces. One of the key challenges for amusement parks is creating unique, personalized experiences for guests that feel both immersive and personalized. With advancements in technology, guests have become more tech-savvy and can easily recognize the methods behind certain special effects or immersive elements. This makes it difficult to create experiences that continue to feel special or surprising. Guests now often expect a higher level of personalization in their interactions with the park. Meeting these expectations without revealing the mechanisms behind the experience is a significant challenge for park operators, who must find new ways to keep guests engaged and entertained.

What is needed is an experience platform that provides integration of various systems, including physical and virtual world elements within those systems to provide customized experiences for guests and control of multiple systems across the venue in real-time that does not suffer from the drawbacks of the prior art. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

The application generally relates to an experience platform system to provide customized experiences for guests that integrates the physical and digital worlds that are safe and secure, real-time, and scalable to engage the audiences in an individual manner.

One embodiment of the present disclosure is directed to an experience platform system having a physical world element. The physical world element includes an augmented reality interface system. The experience platform system also includes a virtual world element, and an experience controller integrating the physical world element and the virtual world element. The integrating includes real-time control of one or both of the physical world element and the virtual world element.

Another embodiment of the present disclosure includes a method for providing an entertainment experience. The physical world element includes an augmented reality interface system. The experience platform system also includes a virtual world element, and an experience controller integrating the physical world element and the virtual world element. The integrating includes real-time control of one or both of the physical world element and the virtual world element.

Another embodiment according to the present disclosure includes a venue that provides physical flying and atmospheric effects tied to AR having real-time control and variability. The system according to the present disclosure permits real-time bi- directional communication between AR (augmented reality) and physical world elements, such as those controlled via the NAVIGATORTM automation system, which may, for example provide atmospheric effects corresponding to the AR environment.

In this embodiment, physical world elements, such as video screens or displays may be integrated with cloud-based scheduling, content Another embodiment according to the present disclosure includes immersive shows with extensive integration between display/projection and crowd movement. In this embodiment, physical world elements, such as computer visions cameras, location tracking sensors or other systems for measuring crowd movement may be combined with reactive projection mapping resulting from virtual world elements, such as big data analysis, artificial intelligence, content profiles or other programmed elements.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

FIG. 1 schematically shows an embodiment of an experience platform system according to an embodiment of the present disclosure.

FIG. 2 schematically shows an alternate embodiment of an experience platform system according to an embodiment of the present disclosure.

FIG. 3 schematically shows an embodiment of a node from the experience platform system of FIG. 2.

FIG. 4 schematically shows an embodiment of an operator console node from the experience platform system of FIG. 2.

FIG. 5 illustrates a data processing system according to an embodiment of the present disclosure.

FIG. 6 schematically shows an embodiment of a sub- or co-process of a node process according to an embodiment of the present disclosure.

FIG. 7 schematically shows an embodiment of an segment reality system according to embodiment of the present disclosure.

FIG. 8 schematically shows an embodiment of an experience platform system for wearable and motor control according to an embodiment of the present disclosure.

FIG. 9 schematically shows an embodiment of an experience platform system showing a user wearing an augmented reality interface system viewing a virtual view of a lighting effect.

FIG. 10 schematically shows an embodiment of an experience platform system showing a user wearing an augmented reality interface system viewing a virtual view of an interactive element.

FIG. 11 schematically shows an embodiment of an experience platform system showing a user wearing an augmented reality interface system utilizing position sensing.

FIG. 12 schematically shows an embodiment of an experience platform system showing a user wearing an augmented reality interface system viewing customized virtual views of a lighting effect.

FIG. 13 schematically shows an embodiment of an experience platform system showing a user wearing an augmented reality interface system viewing warning indicia for hazards.

FIG. 14 schematically shows another embodiment of an experience platform system showing a user wearing an augmented reality interface system viewing warning indicia for hazards.

FIG. 15 schematically shows another embodiment of an experience platform system showing a user wearing an augmented reality interface system viewing indicia indicating clear passage.

FIG. 16 schematically shows an embodiment of an experience platform system showing a user wearing an augmented reality interface system viewing a virtual view of a customized interactive element.

FIG. 17 schematically shows another embodiment of an experience platform system showing a user wearing an augmented reality interface system viewing a virtual view of a customized interactive element.

FIG. 18 schematically shows another embodiment of an experience platform system showing a user wearing an augmented reality interface system viewing a virtual view of a customized interactive element.

Wherever possible, the same reference numbers will be used throughout the drawings to represent the same parts.

### DETAILED DESCRIPTION OF THE INVENTION

The augmented reality interface system and experience platform system according to the present disclosure include embodiments having a system architecture providing an interactive control, where the user's experience can be customized for both enhanced entertainment and safety. For example, the experience platform system may include customized experiences for particular users that integrates the physical and digital worlds in a manner that provides unique experiences, including independent experiences for multiple users in the same venue space. Other examples include the ability to provide content, information, warnings, indicia or other types of information that would not otherwise be visible to a user, which may provide enhanced entertainment and/or safety. Advantages of the augmented reality interface system and experience platform system according to the present disclosure include immersive personalized experiences sharing the same space and stage-set hardware, reducing the need for duplicative stage-set hardware. Still another advantage of the systems of the present disclosure is the ability to have a guest experience or journey that is customized and/or different every visit. Other advantages include the ability for guests to control machinery through the guest's actions. The systems of the present disclosure provide an ability to see what would not otherwise be seen visibly, reducing risk and opportunity for accidents, which reduces costs and insurance burdens.

Augmented reality or AR, as utilized herein, is a technology that overlays digital information, including, but not limited to images, text, 3D objects, sounds or videos onto a user's real-world environment in real time, altering and/or enhancing perception by the user generally without replacing the physical world.

The experience platform system includes embodiments having a system architecture providing an operating system for guest experiences. For example, the experience platform system may include customized experiences for guest, crowds or individuals that integrates the physical and digital worlds that are safe and secure, real- time, and scalable to engage the audiences in an individual manner.

The physical world, as utilized herein, includes sensory perception by a human of an event that occurs (e.g., visual, audio, environmental, motion). Virtual world, as utilized herein, includes information, data or sensory perception by a human of an event that doesn't occur in real-world, but may include effects that are signaled to the human for perception by another sensory input (e.g., audio/visual (A/V) to user alone). The virtual world, as utilized herein, is not limited to known virtual reality systems, but includes other virtual systems, such as virtual spaces and models, profile information and related data (e.g., inputs customized for each unique user (e.g., "personalization")), simulations, physics/game engines, avatars and virtual representations, applications and computer programs, big data/large learning models and artificial intelligence (AI), such as generative Al, as well as augmented reality (AR), extended reality (XR) and mixed reality (MR).

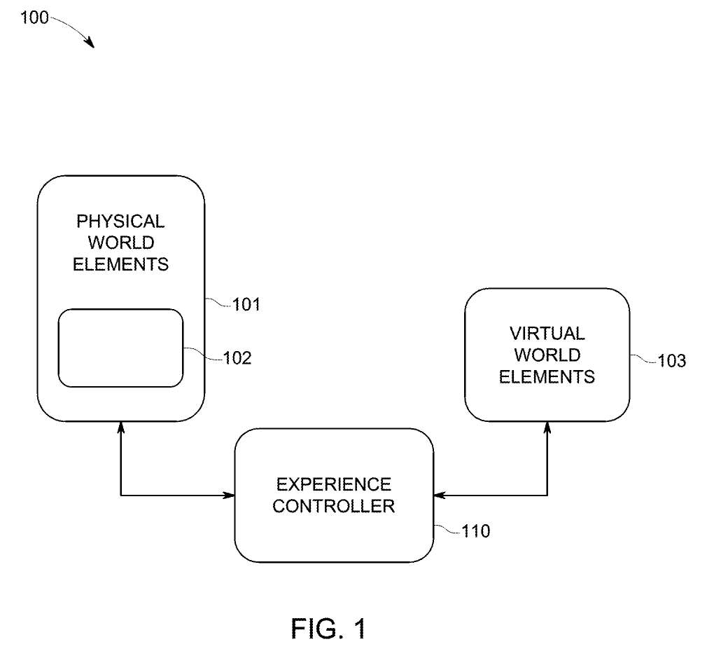

FIG. 1 shows an exemplary embodiment of the experience platform system 100 according to the present disclosure. The experience platform system 100 may include an experience controller 110 integrating physical world elements 101 and virtual world elements 103. Physical world elements, as utilized herein, include at least some tangible objects and real-life interactions with the real-world and include or have corresponding hardware and/or software that provide at least some level of control of the tangible objects. Physical world elements 101 may include operator consoles, remote stations, safety systems, machinery, input/output devices and external systems. For example, physical world elements 101 may include, but are not limited to lifts, chain hoists, winches, elevators, carousels, turntables, hydraulic systems, pneumatic systems, multi- axis systems, linear motion systems (e.g., deck tracks and line sets), audio devices, lighting devices, and/or video devices; input/output devices, such as incremental encoders, absolute encoders, variable voltage feedback devices, resistance feedback devices, tachometers and/or load cells; and external systems, such as show control systems, industrial protocols and third party software interfaces including 0-10 V (volt) systems, Modbus systems, Profibus systems, ArtNet systems, BMS (Building Management System) systems, EtherCat systems, DMX systems, SMPTE (Society of Motion Picture and Television Engineers) systems, VITC systems, MIDI (Musical Instrument Digital Interface) systems, MANET (Mobile Ad hoc NETwork) systems, K-Bus Protocol) systems, ControlNet systems, DeviceNet systems, RS 232 systems, RS 45 systems, CAN bus (Controller Area Network bus) systems, Maya systems, Lightwave systems, Serial systems (including RS 485 and RS 232), Ethernet systems, TCP/IP (Transmission Control Protocol/Internet Protocol) systems, UDP (User Datagram systems, Catalyst systems, 3ds Max or 3D Studio Max systems, and/or a custom designed system. Particularly suitable physical world elements 101 may include, for example, motors/drivers, cameras/computer vision (CV), sensors, lighting elements, sound/acoustic elements, pyrotechnic elements, video screens, point of sale systems, mobile devices/cell phones, and wearables, such as VR/AR/XR headsets. Other physical world elements may include, for example, objects, features or equipment moved by some of the devices noted above, such as floors, ceilings, walls, objects within a space or other physical elements that can be moved by automation/automated systems. In one particularly suitable environment, as shown in FIG. 1, the physical world elements 101 include includes an augmented reality interface system 102 that utilizes augmented reality technology that is capable of displaying virtual world elements 103 that have been integrated via the experience controller 110. In one embodiment, the augmented reality interface system 102 includes an AR headset. Suitable augmented reality interface systems 102 may include, for example, commercially available augmented reality interface systems that include Mixed Reality (MR) headsets, such as VR headsets with video passthrough. Commercially available headsets could be utilized with embodiments of the present disclosure may include, for example, Snap Spectacles, Microsoft HoloLens 2, Magic Leap 2, Apple Vision Pro, Meta Quest 3 / Quest Pro and Varjo XR-3 / XR-4.

Virtual world elements 103, as utilized herein, include elements, such as code or data, that are intangible and/or simulated and reside in the memory of one or more computer system. One embodiment of the control system may include NAVIGATORTM automation system to provide the control one or more of the physical world elements. NAVIGATORTM automation systems may include, for example, systems such as those disclosed in U.S. Patent No. 8,768,492, entitled AUTOMATION AND MOTION CONTROL SYSTEM, which is hereby incorporated by reference in its entirety. Virtual world elements 103 may include models of objects, systems or features that also exist in the physical world or may be models of things that don't exist in the physical world and are entirely virtual. Virtual world elements 103 may include, for example, user profiles, virtual spaces/models, simulators, physics/game engines, avatars, applications, and big data/artificial intelligence (AI). Other examples of virtual world elements 103 include, but are not limited to virtual spaces and models, profile information and related data (e.g., guest journeys, user preferences or other personalized guest information), simulations, physics/game engines, avatars and virtual representations, applications and computer programs, big data/large learning models and artificial intelligence (AI), such as generative Al.

The experience controller 110 may include hardware or software having the ability to communicate and/or transmit signals, data, information or code between physical world elements 101 and virtual world elements in order to provide integrated control of a physical world element 101. In one embodiment, the experience controller 110 includes an arrangement of hardware and/or software that provides real-time control of a physical world element 101. For example, in one embodiment, a user may wear an augmented reality interface system 102, such as an augmented reality (AR) headset allowing the user to see elements of the real world, while simultaneously perceiving a unique experience based on projections through the AR headset resulting from a virtual world model, providing a mix of virtual world elements 103 and physical world elements 101. The experience platform system 100 may include elements of the experience platform system 100 shown and described in U.S. Patent Application No. 19/092,275, filed March 29, 2025, entitled "EXPERIENCE PLATFORM", which is incorporated by reference in its entirety.

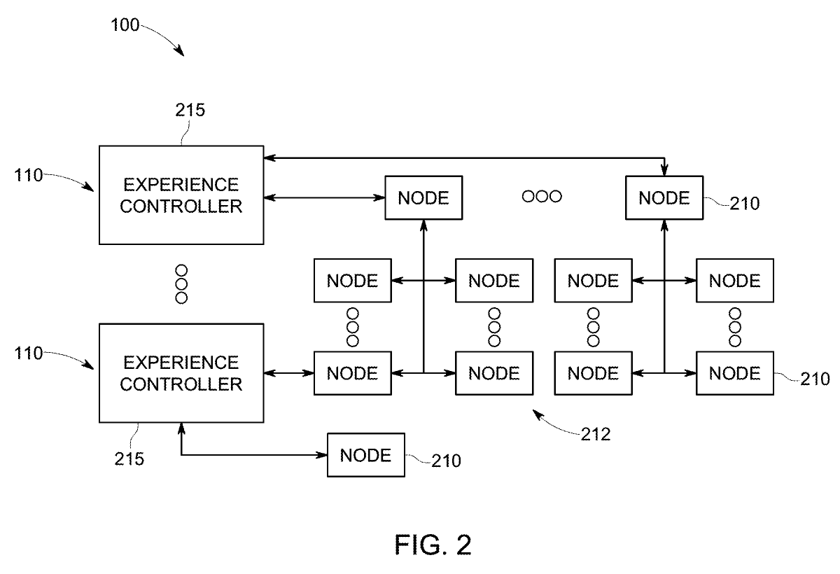

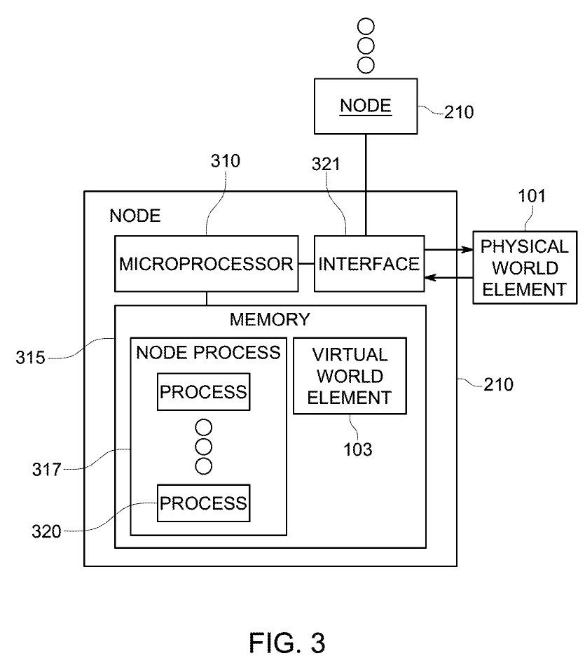

FIG. 2 shows an embodiment of the experience platform system 100 according to the present disclosure. The experience platform system 100 shown in FIG. 2 may be formed from the interconnection of nodes 210. Each node 210 may correspond to a physical world element 101, a virtual world element 103 or both (see for example FIG. 3). By "correspond to", "corresponding to" and grammatical variations thereof, it is meant that the node 210 includes a microprocessor 310 and associated software/firmware that controls or otherwise interacts with the physical world element 101 and/or virtual world element 103 in a manner that provides control, data or information exchange. The experience controller 110 may be an operator console node 215 (e.g., a node having certain additional interface and/or control properties) and may in itself correspond to a physical world element 101 and/or a virtual world element 103. In one exemplary embodiment, the experience controller 110 may may include a computer and/or computer system. The experience controller 110 may enable an operator to interact with the experience platform system 100, i.e., to send data and instructions to the various elements of the experience platform system 100 and to receive data and information from the various elements of the experience platform system 100. In this embodiment, the experience controller 110 may be similar to the other nodes 210 except that the experience controller 110 may further include a graphical user interface (GUI) or human-machine interface (HMI) to enable the operator to interact with the experience platform system 100. For example, in one exemplary embodiment, the operator(s) may make inputs into the system experience controller 110 using one or more input devices, e.g., a pointing device such as a mouse, a keyboard, a panel of buttons, or other similar devices. While FIG. 2 shows the arrangement of nodes 210 including an experience controller 110 as an operator console node 215, the experience controller 110 is not so limited and may include other configurations and arrangements wherein the experience controller 110 provides connection between the physical world element 101 and the virtual world element 103.

As shown in FIG. 2, nodes 210 and experience controller 110 are interconnected with each other. Thus, nodes 210, 215 may communicate, i.e., send and receive data and/or instructions, with any other node 210, 215 in the experience platform system 100. In one exemplary embodiment, a group of nodes 210 may be arranged or configured into a network 212 that interconnects the nodes 210 in the group and provides a reduced number of connections with the other nodes 210, 215. In another exemplary embodiment, nodes 210, 215 and/or node networks 212 may be interconnected in a star, daisy chain, ring, mesh, daisy chain loop, token ring, or token star arrangement or in combinations of those arrangements. In a further exemplary embodiment, the experience platform system 100 may be formed from more or less nodes 210, 215 and/or node networks 212 than those shown in FIG. 2.

In one exemplary embodiment, each node 210, 215 may be independently operated and self-aware, and may also be aware of at least one other node 210, 215. In other words, each node 210, 215 may be aware that at least one other node 210, 215 is active or inactive (e.g., online or offline).

In another exemplary embodiment, each node 210, 215 is independently operated using decentralized processing, thereby allowing the experience platform system 100 to remain operational even if a node 210, 215 may fail because the other operational nodes 210 still have access to the operational data of the nodes 210. Each node 210, 215 may be a current connection into the experience platform system 100, and may have multiple socket connections into the network 212, each providing node 210 communications into the control system through the corresponding node 210, 215. As such, as each individual node 210, 215 is taken "offline," the remaining nodes 210, 215 may continue operating and load share. In a further exemplary embodiment, the control system may provide the operational data for each node 210 to every other node 210, 215 all the time, regardless of how each node 210, 215 is related to each other node 210, 215.

FIG. 3 schematically shows an exemplary embodiment of a node 210. Each node 210 includes a microprocessor 310 and a memory device 315. The memory device 315 may include or store a main or node process 317 that may include one or more sub- or co-processes 320 that are executable by the microprocessor 310. The main or node process 317 provides the networking and hardware interfacing to enable the sub- or co- processes 320 to operate. As shown in FIG. 3, a physical world element 101 may be in communication with node 210 to allow the passage of signals, data and/or instructions to and from the physical world element 101. As shown in the embodiment shown in FIG. 3, while not so limited, signals, data and/or instructions to and from the physical world element 101 may be connected to node 210 by interface 321. Interface 321 may be any suitable electronic interface known for connecting devices or components to computer systems. The signals, data and/or instructions to and from the physical world element 101 may be dynamic information related to the physical world element 101 that is processed by microprocessor 310 or may be signals, data and/or instructions transmitted to other nodes 210 or to the operator console node 215. As shown in FIG. 3, node 210 may include a virtual world element 103 that is integrated into memory device 315. Although FIG. 3 shows a virtual world element 103, the presence of virtual world element 103 may be optional, particularly when node 210 corresponds to physical world element 101. While node 210 of FIG. 3 includes both a physical world element 101 and a virtual world element 103, in other embodiments node 210 may include either a physical world element 101 or a virtual world element 103. The transfer of information may include dynamic or real-time information and the node 210 may gather or receive real-time or dynamic data to be stored at node 210 and/or transmitted to other nodes 210 or the operator console node 215.

In one embodiment, physical world elements 101 may include sensors for data collecting. In certain embodiments, sensors may provide sensing or indication useful for determining a state or property of a physical world element 101 corresponding to node 210. Some examples of dynamic or real-time information that may be measured with sensors may include temperature, current, load or weight (load cell), position, angle, g- force or acceleration (accelerometer), direction of movement, or speed of movement. Suitable sensors may include, but are not limited to inertia sensor (e.g., accelerometers, gyro-sensors, etc.), global positioning system (GPS) sensors, voltage meters, temperature sensors, contact or non-contact displacement sensors (e.g., linear variable differential transformers (LVDT), differential variable reluctance transducers (DVRT)), slide potentiometers, radar sensors, LiDAR sensors, magnetic sensing systems, optical or infrared sensing systems, radio frequency identification (RFID) sensors, computer vision (CV) or any combination thereof. For example, while not so limited, the data from these sensors may be utilized for crowd analysis, individual location identification or behavior analysis. Other conditions may also be sensed with sensors, such as humidity, temperature, odors/chemicals or other environmental conditions that may affect a particular venue or experience.

The microprocessor 310 in a node 210 may operate independently of the other microprocessors 310 in other nodes 210. The independent microprocessor 310 enables each node 210 in the experience platform system 100 to operate or function as a "stand-alone" device or as a part of a larger network 212. In one exemplary embodiment, when the nodes 210 are operating or functioning as part of a network 212, the nodes 210 may exchange information, data and computing power in real time without recognizing boundaries between the microprocessors 310 to enable the experience platform system 100 to operate as a "single computer." In another embodiment, each node 210 may use an embedded motion controller.

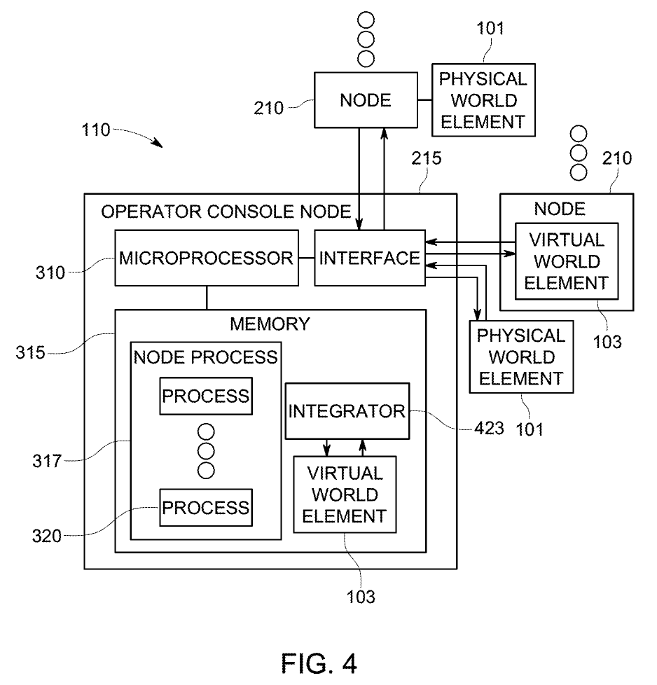

FIG. 4 schematically shows an exemplary embodiment of an experience controller 110 according to an embodiment of the present disclosure. In the embodiment shown in FIG. 4, the experience controller 110 includes an operator console node 215. Each operator console node 215, like node 210, includes a microprocessor 310 and a memory device 315. The memory device 315 may include or store a main or node process 317 that may include one or more sub- or co-processes 320 that are executable by the microprocessor 310. The main or node process 317 provides the networking and hardware interfacing to enable the sub- or co-processes 320 to operate. In addition to the node process 317, memory device 315 includes integrator 423. In these embodiments, the experience controller 110 includes an integrator 423 to provide interaction between the physical world elements 101 with the virtual world elements 103 (see, for example, FIG. 4) resulting in an output for control of physical world elements 101 and/or virtual world elements 103. As shown in FIG. 4, a physical world element 101 may be in communication with operator console node 215 to allow the passage of signals, data and/or instructions to and from the physical world element 101. In addition, operator console node 215 may be in communication with a node 210, such as the node 210 shown in FIG. 3, that is in communication with a physical world element 101. Node 210 or the physical world element 101 may be connected to the operator console node 215 by interface 321. The signals, data and/or instructions to and from the physical world element 101 may be dynamic information related to the physical world element 101 that is processed by microprocessor 310 or may be signals, data and/or instructions transmitted to other nodes 210 or to the operator console node 215. As shown in FIG. 4, operator console node 215 may include a virtual world element 103 that is integrated into memory device 315. In addition, a connected node 210 may include a virtual world element 103, which includes signals, data and/or instructions to and from the virtual world element 103 in node 210 to operator console node 215. Although FIG. 4 shows virtual world elements 103 integrated into the operator console node 215 and in node 210 connected to operator console node 215, these are not both required. One or both of the locations of virtual world elements 103 may be provided. Likewise, while operator console node 215 of FIG. 4 includes both a physical world element 101 directly connected to the operator console node 215 and a physical world element 101 connected to a node 210, which is connected to the operator console node 215, both are not required. One or both of the location of physical world elements 101 may be provided.

Integrator 423 of operator console node 215 receives signals, data and/or instructions from both physical world elements 101 and virtual world elements 103 and provides an output set of signals, data and/or instructions that communicated back to one or both of the physical world elements 101 and the virtual world elements 103 to provide an integrated response that provides a connection and relationship between the physical world element 101 and the virtual world element 103. The integrator 423 may be code, information, instructions or data or may include code, information, instructions or data that is arranged and configured to collect inputs from the physical world element(s) 101 and virtual world element(s) 103 and generate smart outputs to the physical world element(s) 101 based upon the inputs collected. The integrator 423 may include primitive and abstracted goals that may be programmed into the integrator 423 or provided by a user and utilizes these goals to generate the smart outputs based upon these goals and the real-time inputs from the physical world element(s) 101 and the virtual world element(s) 103. That is, the integrator 423 works within the experience platform system 100 to collect these bespoke systems and data together as inputs to make smart, predictive decisions about what all of the outputs do. The primitive and abstracted goals provide basic guidance to the integrator 423 to allow a user to provide a high-level control and/or some direction and/or theme to the predictive decisions and control outputted by the integrator 423 to the physical world elements 101. For example, the integrator 423 may use artificial intelligence, big data or other computing systems to integrate the inputs based on the primitive and abstracted goals to generate the predictive outputs in real time. The experience platform system 100 integrates the real-time inputs from the physical world element(s) 101 and the virtual world element(s) 103 significantly faster than humans could do. The ultimate effect of utilizing the integrator 423 is that experiences may effectively emulate having a guide or VIP experience for every single guest, helping optimize every system around them.

In one embodiment, sensor fusion may be handled by the NAVIGATORM system, as it is connected to all physical-world devices and sensors, including the AR headset. Based on data coming from physical sensors and on events generated by the software running on the AR headset, the NAVIGATORTM system continuously updates an in- memory representation of the virtual world state (e.g., the absolute position of physical and virtual objects (i.e., the physical world elements 101), the state of physical and virtual lights, etc.). The virtual world state (i.e., from the virtual world element 103) - either partially or in its entirety - is then communicated to the AR headset for rendering and display; this state also acts as a control surface, where updates can drive synchronized actions on physical objects attached to machinery.

Due to the latency inherent in the wireless connection between the AR headset and the NAVIGATORTM system, certain operations are delegated to the headset software. In particular, fine-grained user interactions that require low-latency processing and immediate user feedback are handled locally by the headset, while the NAVIGATORTM system remains the sole source of truth for the global state of the virtual world (i.e., the virtual world elements 103).

For example, 3D rendering of the virtual world from the headset's point of view is performed locally by the headset, using its own positioning system. However, the absolute positions of virtual-world objects themselves are still provided by the Navigator system.

A similar approach may be used for hand tracking: content positioning relative to the user's hands is processed locally on the headset to minimize latency, while higher- level interaction events are sent back to the Navigator and correlated with other system information (such as the state of a light).

The microprocessor 310 in an operator console node 215 may operate independently of the other microprocessors 310 in other an operator console nodes 215. The independent microprocessor 310 enables each operator console node 215 in the experience platform system 100 to operate or function as a "stand-alone" device or as a part of a larger network 212. In one exemplary embodiment, when the operator console nodes 215 is operating or functioning as part of a network 212, the operator console nodes 215 may exchange information, data and computing power in real time without recognizing boundaries between the microprocessors 310 to enable the experience platform system 100 to operate as a "single computer."

In one example, the virtual world element 103 from the memory device 315 of the operator console node 215 or the virtual world element 103 corresponding to a connected node 210 may be a representation of a controlled device. For example, the represented device may be a physical world element 101, such as a lift, chain hoist, winch, elevator, carousel, turntable, hydraulic system, pneumatic system, multi-axis system, linear motion system, audio device, lighting device, or video device. The virtual world element 103 including this representation may be a 3-dimensionsal (3-D) model of the device. The representation may include information regarding the capabilities of device that may be utilized in calculations, algorithms or control schemes to control devices. The integrator 423 may gather information from physical world elements 101, which may include the device represented in the virtual world element 103. That is, the integrator 423 may dynamically obtain data relating to the device, including the device's physical configuration and/or properties, from physical sources, such as from sensors corresponding to the device. The data obtained by the integrator 423 may be communicated to or combined with information from the virtual world element 103 to provide an updated 3-dimensional model of the device which may be displayed on, for example, a graphical user interface (GUI) or human-machine interface (HMI) to provide real time information about the device. In addition to displaying the information in the GUI, the experience platform system 100 processes and provides instructions to the physical world elements 101 on what those elements should be doing. By providing the processing in real-time, every input change to the integrator 423 effectively triggers all outputs (i.e., control of the physical world elements 101) to reconsider what they should and to provide the adjusted control of that element.

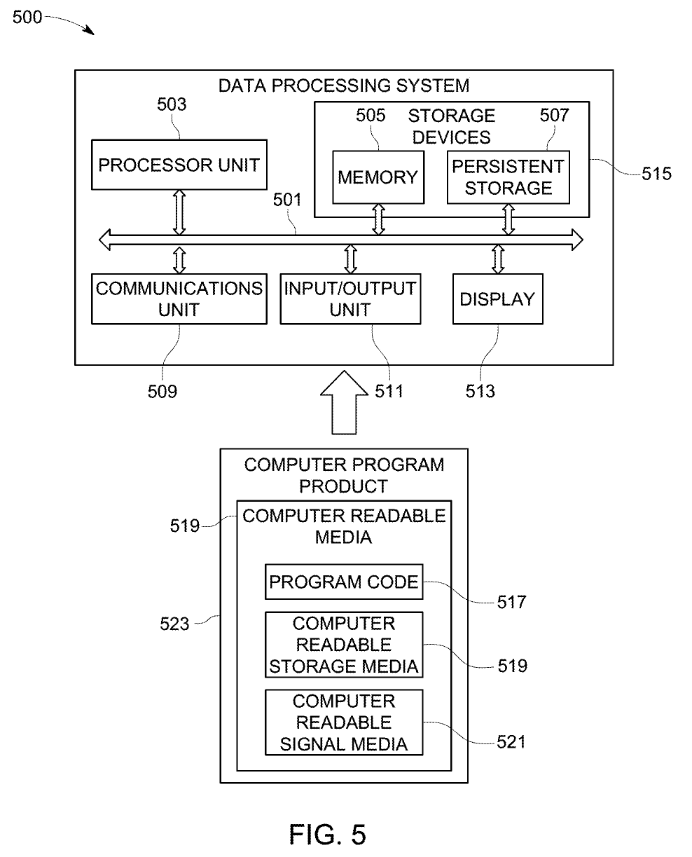

FIG. 5 shows an exemplary illustration of a data processing system 500 suitable for use as components of the system, including, but not limited to node 210 and experience controller 110. In this illustrative example, data processing system 500 may include communications fabric 501, which provides communications between processor unit 503, memory 505, persistent storage 507, communications unit 509, input/output (I/0) unit 511 and display 513. While FIG. 5 shows various elements including processor unit 503, memory 505, persistent storage 507, communications unit 509, input/output (I/0) unit 511, and display 513, some or all of the elements may be present for particular configurations of node 210 and/or experience controller 110. For example, certain nodes 210 may not utilize input/output (I/0) unit 511 and display 513. The utilization or particular components is dependent upon the functionality needed for a particular node 210 or experience controller 110.

Processor unit 503 may be one or a number of processors, a multi-processor core, or some other type of processor, depending on the particular implementation. A number, as used herein with reference to an item, means one or more items. Further, processor unit 503 may be implemented using a number of heterogeneous processor systems in which a main processor is present with secondary processors on a single chip. As another illustrative example, processor unit 503 may be a symmetric multi- processor system containing multiple processors of the same type.

Memory 505 and persistent storage 507 are examples of storage devices 515. A storage device is any piece of hardware that is capable of storing information, such as, for example, without limitation, data, program code 517 in functional form, and/or other suitable information either on a temporary basis and/or a permanent basis. Storage devices 515 may also be referred to as computer readable storage devices 515 in these examples. Memory 505, in these examples, may be, for example, a random access memory or any other suitable volatile or non-volatile storage device. Persistent storage 507 may take various forms, depending on the particular implementation.

For example, persistent storage 507 may contain one or more components or devices. For example, persistent storage 507 may be a hard drive, a flash memory, a rewritable optical disk, a rewritable magnetic tape, or some combination of the above. The media used by persistent storage 507 also may be removable. For example, a removable hard drive may be used for persistent storage 507.

Communications unit 509, in these examples, provides for communications with other data processing systems 500 or devices. In these examples, communications unit 509 is a network interface card. Communications unit 509 may provide communications through the use of either or both physical and wireless communications links.

Input/output (I/0) unit 511 allows for input and output of data with other devices that may be connected to data processing system 500. For example, input/output (I/0) unit 511 may provide a connection for user input through a keyboard, a mouse, and/or some other suitable input device. Further, input/output (I/0) unit 511 may send output to a printer. Display 513 provides a mechanism to display information to a user.

Instructions for the operating system, applications, and/or programs may be located in storage devices 515, which are in communication with processor unit 503 through communications fabric 501. In these illustrative examples, the instructions are in a functional form on persistent storage 507. These instructions may be loaded into memory 505 for execution by processor unit 503. The processes of the different embodiments may be performed by processor unit 503 using computer implemented instructions, which may be located in a memory, such as memory 505.

These instructions are referred to as program code 517, computer usable program code, or computer readable program code that may be read and executed by a processor in processor unit 503. The program code 517 in the different embodiments may be embodied on different physical or computer readable storage media 519, such as memory 505 or persistent storage 507.

Program code 517 is located in a functional form on computer readable storage media 519 that is selectively removable and may be loaded onto or transferred to data processing system 500 for execution by processor unit 503. Program code 517 and computer readable storage media 519 form computer program product 523 in these examples. In one example, computer readable storage media 519 may be computer readable storage media 519 or computer readable signal media 521. Computer readable storage media 519 may include, for example, an optical or magnetic disk that is inserted or placed into a drive or other device that is part of persistent storage 507 for transfer onto a storage device 515, such as a hard drive, that is part of persistent storage 507. Computer readable storage media 519 also may take the form of a persistent storage 507, such as a hard drive, a thumb drive, or a flash memory, that is connected to data processing system 500. In some instances, computer readable storage media 519 may not be removable from data processing system 500.

Alternatively, program code 517 may be transferred to data processing system 500 using computer readable signal media 521. Computer readable signal media 521 may be, for example, a propagated data signal containing program code 517. For example, computer readable signal media 521 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 517 may be downloaded over a network 212 to persistent storage 507 from another device or data processing system 500 through computer readable signal media 521 for use within data processing system 500. For instance, program code 517 stored in a computer readable storage medium in a server data processing system 500 may be downloaded over a network 212 from the server to data processing system 500. The data processing system 500 providing program code 517 may be a server computer, a client computer, or some other device capable of storing and transmitting program code 517.

The different components illustrated for data processing system 500 are not meant to provide architectural limitations to the manner in which different embodiments may be implemented. The different illustrative embodiments may be implemented in a data processing system 500 including components in addition to or in place of those illustrated for data processing system 500. Other components shown in FIG. 5 can be varied from the illustrative examples shown. The different embodiments may be implemented using any hardware device or system capable of running program code 517. As one example, the data processing system 500 may include organic components integrated with inorganic components and/or may be comprised entirely of organic components excluding a human being. For example, a storage device may be comprised of an organic semiconductor.

In another illustrative example, processor unit 503 may take the form of a hardware unit that has circuits that are manufactured or configured for a particular use. This type of hardware may perform operations without needing program code 517 to be loaded into a memory 505 from a storage device to be configured to perform the operations.

For example, when processor unit 503 takes the form of a hardware unit, processor unit 503 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 517 may be omitted because the processes for the different embodiments are implemented in a hardware unit.

In still another illustrative example, processor unit 503 may be implemented using a combination of processors found in computers and hardware units. Processor unit 503 may have a number of hardware units and a number of processors that are configured to run program code 517. With this depicted example, some of the processes may be implemented in the number of hardware units, while other processes may be implemented in the number of processors.

The different illustrative embodiments can take the form of an entirely hardware embodiment, an entirely software embodiment, or an embodiment containing both hardware and software elements. Some embodiments are implemented in software, which includes but is not limited to forms such as, for example, firmware, resident software, and microcode.

Furthermore, the different embodiments can take the form of a computer program product 523 accessible from a computer usable or computer readable medium providing program code 517 for use by or in connection with a computer or any device or system that executes instructions. For the purposes of this disclosure, a computer usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non-limiting examples of a computer readable medium include a semiconductor or solid-state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W), and DVD.

Further, a computer usable or computer readable medium may contain or store a computer readable or computer usable program code 517 such that when the computer readable or computer usable program code 517 is executed on a computer, the execution of this computer readable or computer usable program code 517 causes the computer to transmit another computer readable or computer usable program code 517 over a communications link. This communications link may use a medium that is, for example, without limitation, physical or wireless.

The data processing system 500 is suitable for storing and/or executing computer readable or computer usable program code 517 will include one or more processors coupled directly or indirectly to memory elements through a communications fabric 501, such as a system bus. The memory elements may include local memory employed during actual execution of the program code 517, bulk storage, and cache memories which provide temporary storage of at least some computer readable or computer usable program code 517 to reduce the number of times code may be retrieved from bulk storage during execution of the code.

Input/output (I/O) unit 511 or I/O devices can be coupled to the system either directly or through intervening I/O controllers. These devices may include, for example, without limitation, keyboards, touch screen displays, and pointing devices. Different communications adapters may also be coupled to the system to enable the data processing system 500 to become coupled to other data processing systems 500 or remote printers or storage devices through intervening private or public networks. Non- limiting examples of modems and network adapters are just a few of the currently available types of communications adapters.

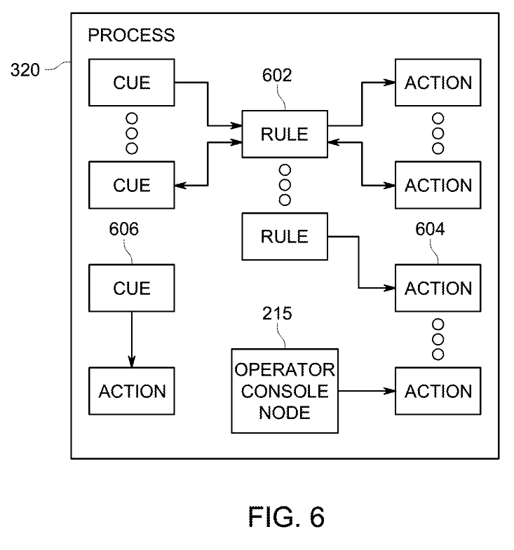

FIG. 6 schematically shows an exemplary embodiment of a sub- or co-process for node 210, 215. Each sub- or co-process 320 includes one or more actions 604 that may be triggered by one or more rules 602 and/or one or more cues 606 or by a direct command from an operator console node 215. In another embodiment, one or more cues 606 may trigger one or more rules 602 or one or more actions 604 may trigger one or more rules 602. For example, one or more rules 602 may initiate one or more actions 604 in response to one or more cues 606.

In one exemplary embodiment, each rule 602 may be an if-then or an and-or statement or other similar type of case or logic statement. The cues 606 may be associated with the "if" conditions of the rule and may include measured parameters, e.g., velocities, accelerations, positions, voltages, currents, etc., and logic inputs, e.g.,"1s" or "Os," from other nodes 210 or devices. The actions 604 may be associated with the "then" portion of the rule and may include controlling an operating speed of the machine(s) associated with the node or device, sending messages or commands to other nodes 210 or devices, changing operational status, e.g., on or off, of system components, e.g., lights, relays or switches.

Big data, as utilized herein, includes large, complex datasets that are generally too large for traditional data processing tools and techniques to handle efficiently. In the context of data analysis, big data typically involves the collection, storage, processing, and analysis of massive amounts of structured, semi-structured, and unstructured data from a variety of sources. The analysis of big data aims to uncover patterns, trends, and insights that can drive decision-making, predictions, and innovations, including customization and personalization taking into account, for example, profiles of individuals participating in an entertainment experience. Advanced analytical techniques, such as machine learning, artificial intelligence, and statistical models, may be employed to identify correlations, predict future trends, and optimize processes. Machine learning, AI, statistical models, etc., used to analyze big data may be used as inputs to the experience controller 110 for analysis and integration.

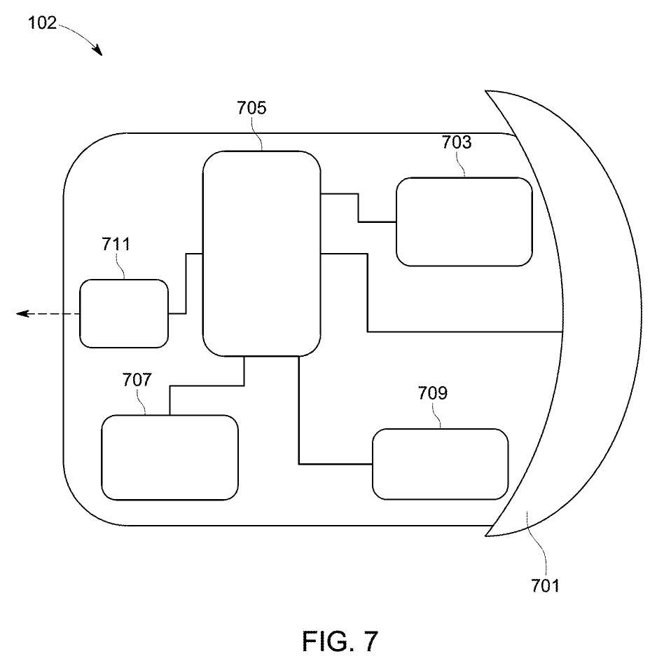

FIG. 7 shows an augmented reality interface system 102 according to an embodiment according to the present disclosure. The augmented reality interface system 102 may be for example, an AR headset. The augmented reality interface system 102, as shown in FIG. 7, includes a display system 701, sensors 703, a headset processor 705, a power source 707, input/interaction devices 709 and headset Interface 711 electrically connected to permit the display 513 to a user of augmented reality. The display system 701 includes components that display 513 the augmented visuals. For example, the display system 701 may include a lens or similar structure that allows the viewer to both view real-world components, while simultaneously being able to display virtual components over or in addition to the real-world components. The display system 701 according to the present disclosure may include, for example, waveguides, lightguides, lenses, combiners for overlaying digital imagery, micro projectors, display engines (e.g., LED, LCOS, OLED, etc.), holographic optical elements, diffractive optical elements, and combinations thereof. The sensors 703 include any suitable sensor devices for providing real time awareness of the environment and user behavior, including for example, position or movement parameters. Suitable sensors 703 for use with the augmented reality interface system 102 may include, for example, environmental /mapping sensors, depth sensors (e.g., time of flight, structured light, or LiDAR), video camera (e.g., RGB camera), SLAM sensors (e.g., for spatial mapping), motion / position sensors, Inertial Measurement Unit (IMU) (e.g., accelerometer + gyroscope + magnetometer), head tracking sensors, eye tracking cameras, and combinations thereof. The headset processor 705 according to the present disclosure may include, for example, a CPU and GPU, such as the data processing systems 500 as shown and described above with respect to FIG. 5, to provide onboard processing capability to provide the desired processing and control the augmented reality interface system 102. The power source 707 may include for example, batteries, power management circuitry, AC power sources, DC power sources or any other suitable source of power. The augmented reality interface system 102 according to an embodiment according to the present disclosure also includes input/interaction devices 709 to provide user input and/or interaction. The input/interaction devices 709 may include, for example, gesture tracking sensors or cameras, eye tracking sensors (e.g., for pupil recognition, foveated rendering), voice control systems, tactile inputs (e.g., buttons, touchpads, or gesture sensitive surfaces), handheld controllers, audio system (e.g., speakers / open ear audio drivers), microphones (e.g., for voice commands and ambient awareness) and combinations thereof. In addition, the augmented reality interface system 102 includes a headset Interface 711 any suitable components for communication to other components to the experience platform system 100. For example, headset interface 711 may wired or wireless, and may include Wifi, Bluetooth, USB-type connections, cellular (e.g., 4G, 5G) or other known wired or wireless interfaces. The AR headset may also include both persistent storage and volatile memory.

The augmented reality interface system 102 according to an embodiment according to the present disclosure may, for example, locate users or guests in a venue or space, including position and orientation of the user's head, locate guest's hands and recognize hand gestures, send data to one or many processors that control stage-set - machinery, light, sensors, etc., display content (image, text and sound) based on the state of the stage-set, display content (image, text and sound) anchored to an element of the stage-set, and share states through a processor. In addition, in certain embodiments. content can be stored in the headset, can be streamed to the headset and can be generated in the headset by using stage-set state and headset sensors. In certain embodiments, the experience controller 110 can send data to AR headset to report stage-set state and position, can change stage-set state in real-time from AR headset localization and can trigger stage-set a programmed sequence of events from AR headset position or gesture recognition.

Likewise in another embodiment, AR headsets as physical world elements 101 in the experience platform system 100 according to the present disclosure may utilize, for example, position information and/or gesture information to provide control and/or content to the AR headsets or other physical world elements 101.

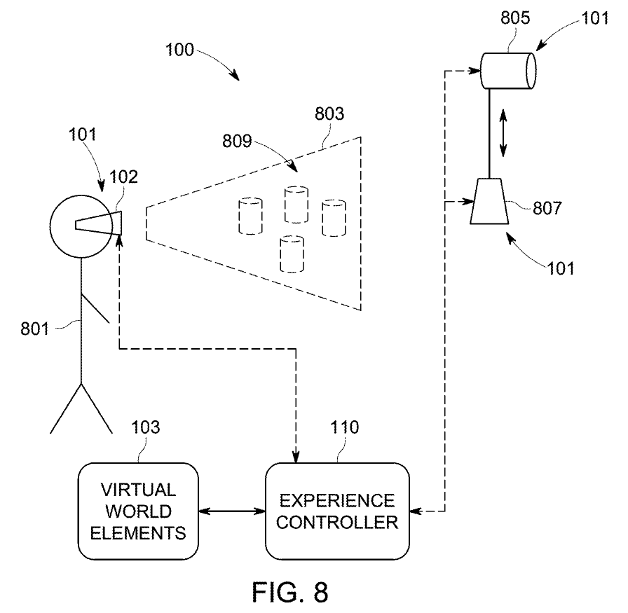

FIG. 8 shows a schematic view of an exemplary embodiment of an experience platform system 100 according to the present disclosure shows a schematic view of an embodiment of the present disclosure showing a user 801 wearing an augmented reality interface system 102, which, in this embodiment, is an AR headset in an adaptive physical environment. The AR headset allows a view area 803 for user 801, which is an area that includes vision for the user of physical elements that are normally visible to the user 801 and AR content 809, which are images and video that are projected for the user 801 to view in addition to the physical elements normally visible. More particularly, as shown in FIG. 8, the experience controller 110 integrates data, signals and information from physical world elements 101 and virtual world elements 103 to control a winch 805 and a lighting element 807 as well as provide AR content 809, visible in view area 803, for the augmented reality interface system 102. For example, position, location and gesture recognition data transmitted from the AR headset to experience controller 110. Position, location and status data for winch 805 and lighting element 807 are likewise transmitted from winch 805 and lighting element 807 to experience controller 110. The data, signals and/or information received by experience controller 110 is integrated and transmitted back to the augmented reality interface system 102 (i.e., in the form of personalized content for display), the winch 805 (i.e., in the form of control instructions for raising or lowering the lighting element 807) and the lighting element 807 (i.e., in the form of customized lighting patterns). The resultant control provides a customized/personalized experience integrating the visuals provided to the user 801 through the augmented reality interface system 102, while simultaneously altering the physical environment with control of the winch 805 and lighting element 807. While the system of FIG. 8, is shown with one user 801, an augmented reality interface system 102, winch 805 and lighting element 807, the disclosure is not so limited and may include any number of users 801, augmented reality interface systems 102, winches 805 and lighting elements 807, which may all be simultaneously controlled to provide individual, customized, real-time experiences for the users 801.

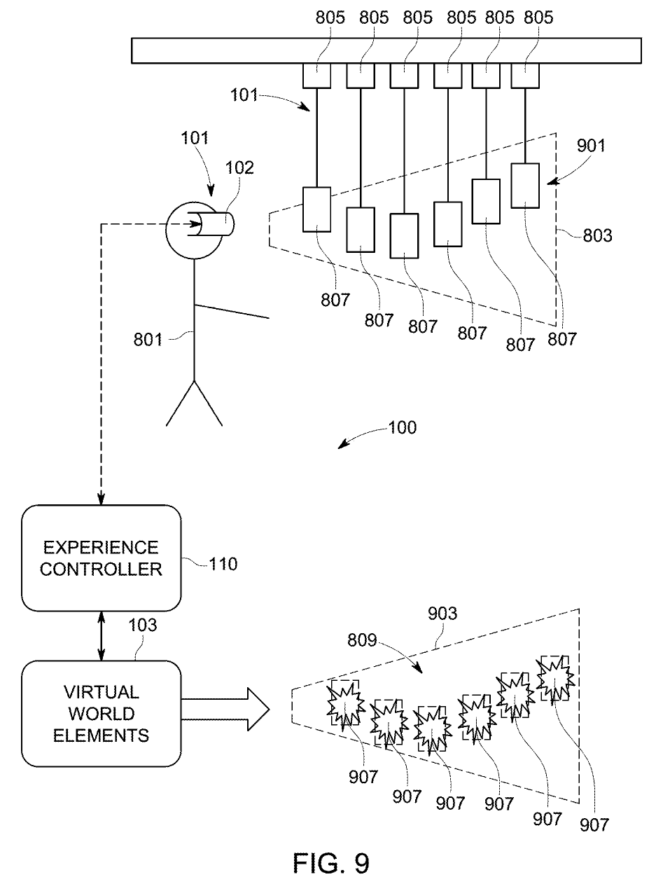

FIG. 9 shows a schematic view of an exemplary embodiment of an experience platform system 100 according to the present disclosure shows a schematic view of an embodiment of the present disclosure showing a user 801 wearing an augmented reality interface system 102, which, in this embodiment, is an AR headset in an adaptive physical environment. The experience platform system 100 includes a user 801 and a series of lighting elements 807 suspended from winches 805, which are controlled by the experience controller 110 to lift or lower the lighting elements 807. The AR headset allows a view area 803 for user 801, which is an area that includes vision for the user 801 of physical elements that are normally visible to the user 801 and AR content 809, which are images and video that are projected for the user 801 to view in addition to the physical elements normally visible. In FIG. 9, the view area 803 shows the physical view 901, which are the elements that are visible to the user 801 excluding the AR content 809. In addition, FIG. 9 shows the virtual view 903 that overlays AR content 809 in addition to things that are visible on the physical view 901. As shown in the embodiment in FIG. 9, in the virtual view 903, the lighting elements 807 include a lighting effect 907 which is the AR content 809 that overlays the lighting elements 807. The lighting effect 907 may be include, for example, images, video, colored lighting or other effects that provide a visual effect. The lighting effect 907 may be stored in the virtual world elements 103 and may include a customized lighting effects 907 that corresponds to the specific user 801, for example from a profile corresponding to user 801 stored in the virtual world elements 103.

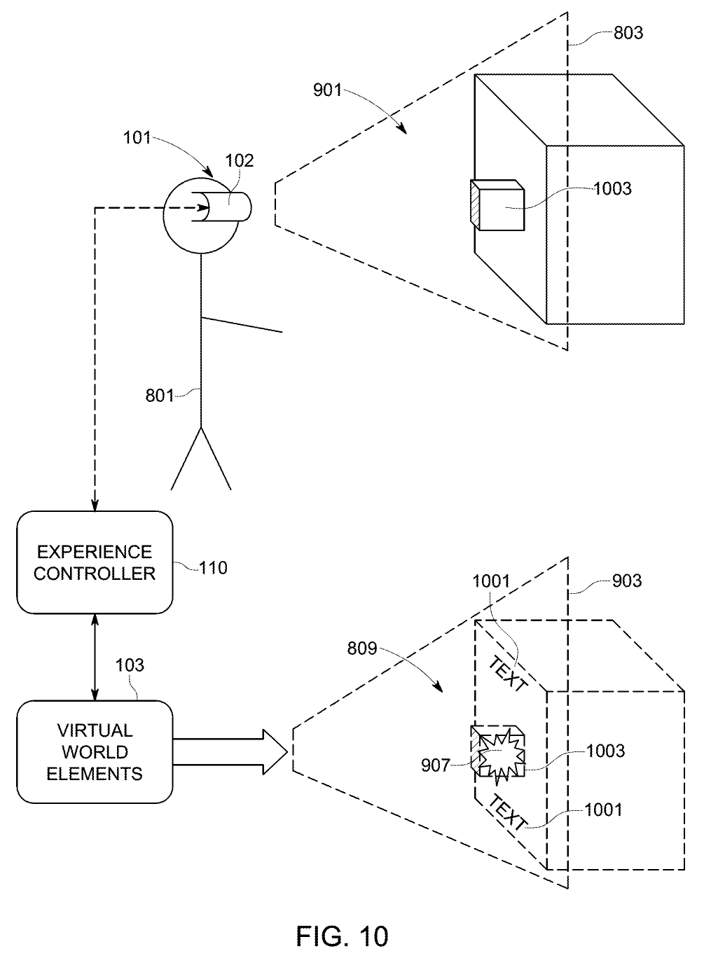

FIG. 10 shows a schematic view of an exemplary embodiment of an experience platform system 100 according to the present disclosure shows a schematic view of an embodiment of the present disclosure showing a user 801 wearing an augmented reality interface system 102, which, in this embodiment, is an AR headset in an adaptive physical environment. The AR headset allows a view area 803 for user 801, which is an area that includes vision for the user of physical elements that are normally visible to the user 801 and AR content 809, which are images and video that are projected for the user 801 to view in addition to the physical elements normally visible. In FIG. 10, the view area 803 shows the physical view 901, which are the elements that are visible to the user 801 excluding the AR content 809. In addition, FIG. 10 shows the virtual view 903 that overlays AR content 809 in addition to things that are visible on the physical view 901. In the embodiment shown in FIG. 10, there is an interactive element 1003 that is a button, lever or other similar device that the user 801 may toggle or otherwise interact with. As shown in the embodiment in FIG. 10, in the virtual view 903, the interactive element 1003 includes a lighting effect 907 and text 1001 which are the AR content 809 that overlays the interactive feature 1003. The lighting effect 907 may be include images, video, colored lighting or other effects that provide a visual effect. The lighting effect 907 and text 1001 may be stored in the virtual world elements 103 and may include a customized lighting element 807 that corresponds to the specific use 801, for example from a profile corresponding to user 801 stored in the virtual world elements 103. For example, a user 801 may be on a quest or mission that has variable pathways or outcomes and the particular instructions shown as text 1001 and/or the lighting effect 907 shown may be varied for the particular quest, mission and/or user 801.

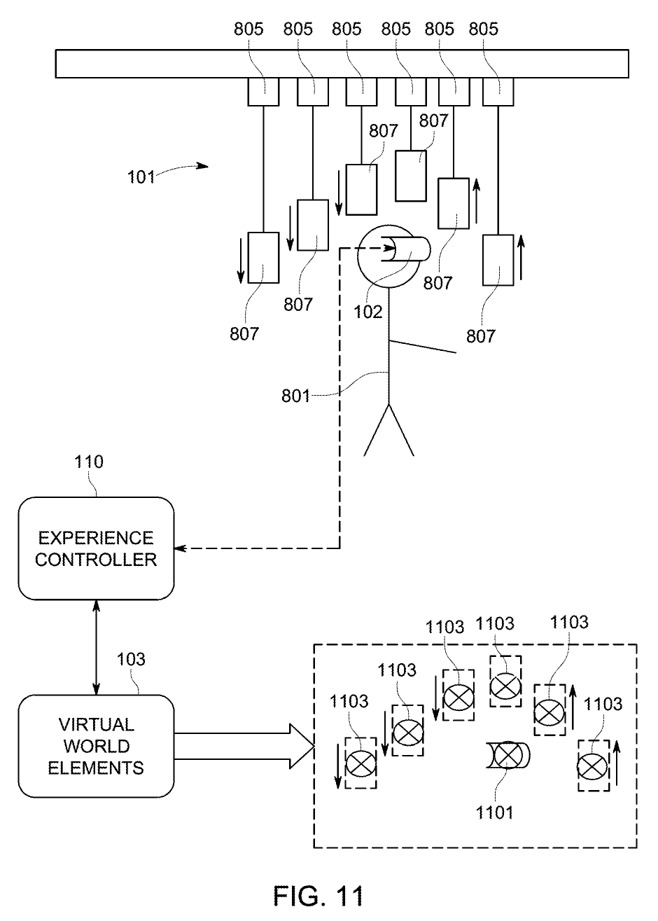

FIG. 11 shows a schematic view of an exemplary embodiment of an experience platform system 100 according to the present disclosure shows a schematic view of an embodiment of the present disclosure showing a user 801 wearing an augmented reality interface system 102, which, in this embodiment, is an AR headset in an adaptive physical environment. The experience platform system 100 includes a user 801 and a series of lighting elements 807 suspended from winches 805, which are controlled by the experience controller 110 to lift or lower the lighting elements 807. In the embodiment shown in FIG. 11, the virtual world elements 103 include user location 1101 and physical element location 1103. The user location 1101 is provided by the sensors in the augmented reality interface system 102. The physical world element locations 1103 are provided by any suitable sensors capable of sensing or otherwise calculating the location of the lighting elements 807. The experience controller 110 receives the virtual world elements 103 showing desired relative positions between the physical world element locations 1103 and the user location 1101 and controls winches 805 to move the lighting elements 807 to maintain the desired distance as shown in the virtual world elements 103. For example, the experience platform system 100 may allow a user 801 to pass through a plurality of lighting elements 807 that would otherwise be in the way of the user 801, moving the lighting elements 807 out of the way to permit passage of the user 801. Other uses of relative position, such as the embodiment shown in FIG. 11, may allow customized environments that automatically move or interact in a manner enhance the user experience by having environments that react to the user's position and/or motion.

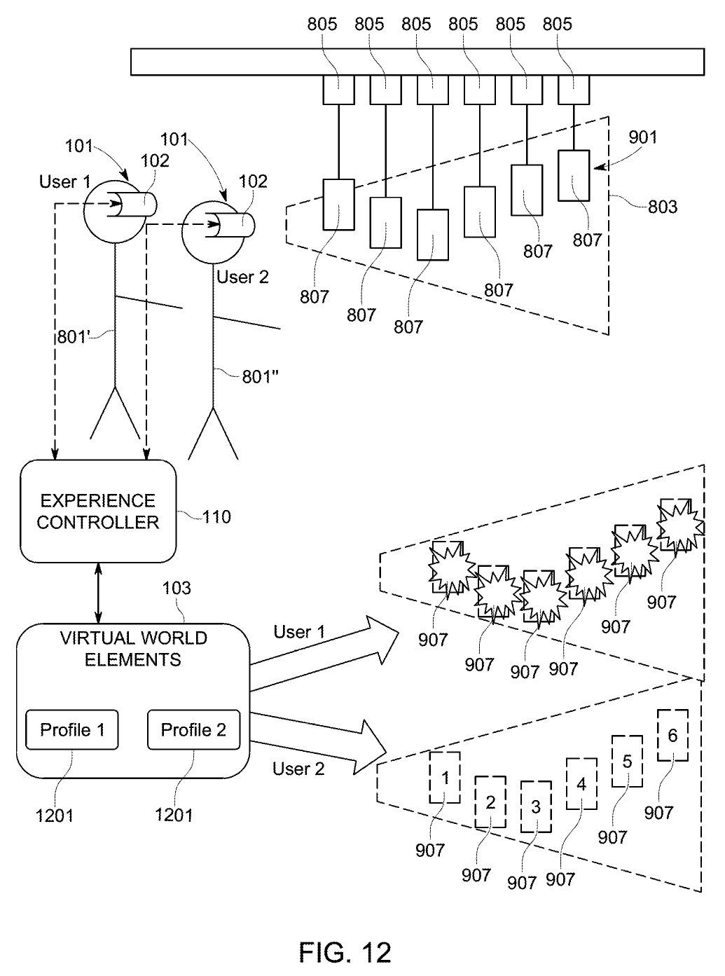

FIG. 12 shows a schematic view of an exemplary embodiment of an experience platform system 100 according to the present disclosure shows a schematic view of an embodiment of the present disclosure showing a first user 801' and a second user 801", each wearing an augmented reality interface system 102, which, in this embodiment, are AR headsets in an adaptive physical environment. The experience platform system 100 includes users 801', 801" and a series of lighting elements 807 suspended from winches 805, which are controlled by the experience controller 110 to lift or lower the lighting elements 807. The AR headset allows a view area 803 for users 801', 801", which is an area that includes vision for the user of physical elements that are normally visible to the user and AR content 809, which are images and video that are projected for the user to view in addition to the physical elements normally visible. In FIG. 12, the view area 803 shows the physical view 901, which are the elements that are visible to users 801', 801", excluding the AR content 809. In addition, FIG. 12 shows the virtual view 903 that overlays AR content 809 in addition to things that are visible on the physical view 901. As shown in the embodiment in FIG. 12, in the virtual view 903, the lighting elements 807 include a lighting effect 907' that is customize for first user 801', which is the AR content 809 that overlays the lighting elements 807. Also, the virtual view 903, the lighting elements 807 include a lighting effect 907" that is customize for second user 801", which is the AR content 809 that overlays the lighting elements 807. As shown, the lighting effect 907 may be include, for example, images, video, colored lighting or other effects that provide a visual effect and need not be the same or the same format. The lighting effect 907 may be stored in the virtual world elements 103 in individual profiles 1201 and may include a customized lighting effects 907 that corresponds to the specific users 801' 801". For example, profiles 1201 may include information and data regarding specific users 801 that provide the lighting effects 907 that correspond with the user 801 and/or a story, quest or mission related to a specific user. Any number of users 801 may be provided and each of the users 801 may have customized lighting effects 907 that may be the same or different than other users 801.

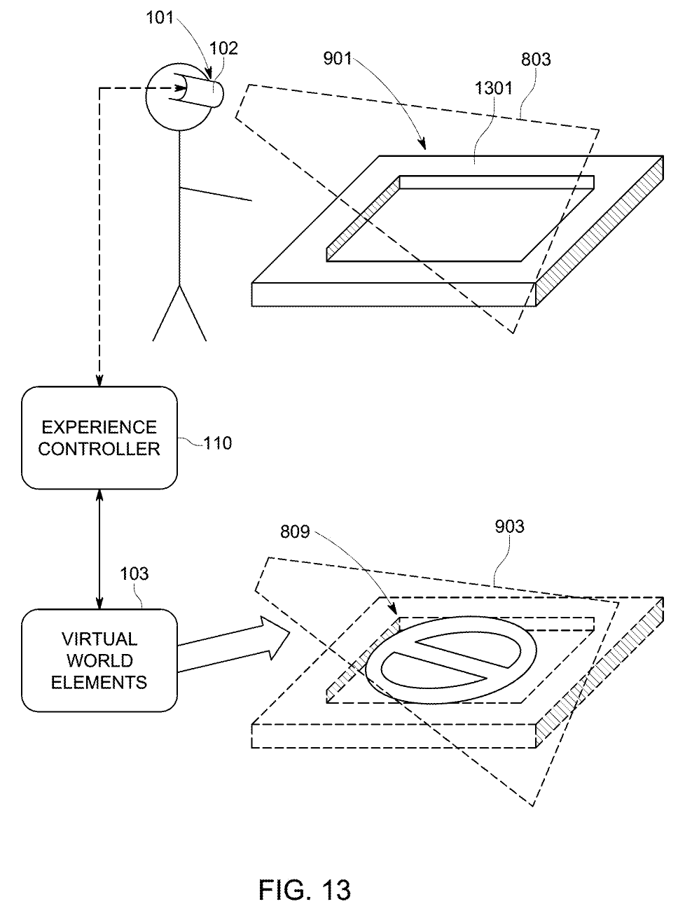

FIG. 13 shows a schematic view of an exemplary embodiment of an experience platform system 100 according to the present disclosure shows a schematic view of an embodiment of the present disclosure showing a user 801 wearing an augmented reality interface system 102, which, in this embodiment, is an AR headset in an adaptive physical environment. The embodiment shown in FIG. 13 shows an embodiment of an experience platform system 100 where an AR headset is used to highlight objects or elements on a floor system 1301 that may not be otherwise visible to the user 801. As shown in FIG. 13, the AR headset allows a view area 803 for user 801, which is an area that includes vision for the user of physical elements that are normally visible to the user and AR content 809. While the view area 803 may otherwise allow visibility of the floor system 1301, the vision may be obstructed by low lighting, fog effects or other conditions that might obstruct the view. However, as shown in FIG. 13, the virtual view 903 and the AR content 809 may include indicia of what might be obscured or a warning of what might be dangerous and may be displayed to the user 801. For example, if a stage lift is down, a hole exists in the stage (i.e., floor system 1301). This embodiment provides users 801 with the ability to see where that hole is while it is dark and allows them to move around safely in the dark. In other embodiments, the AR content 809 could be used to signal performers of key moments in the show actions like when it is clear for them to move on to the next part of the show based on where physical objects are. The AR content 809 is stored as virtual world elements 103 and are determined from either stored locations or physical world elements 101, such as, location, position or velocity sensors. The locations and indicia are saved in as virtual world elements 103 and are provided to the experience controller 110, where the locations and indicia are integrated and provided to the AR headset to display to the user.

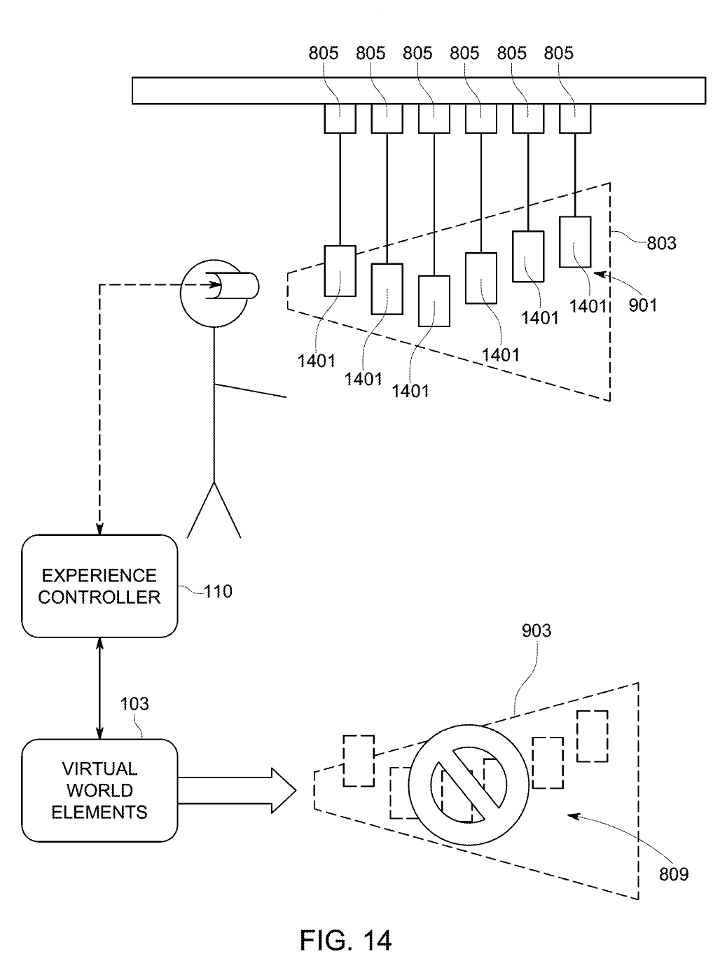

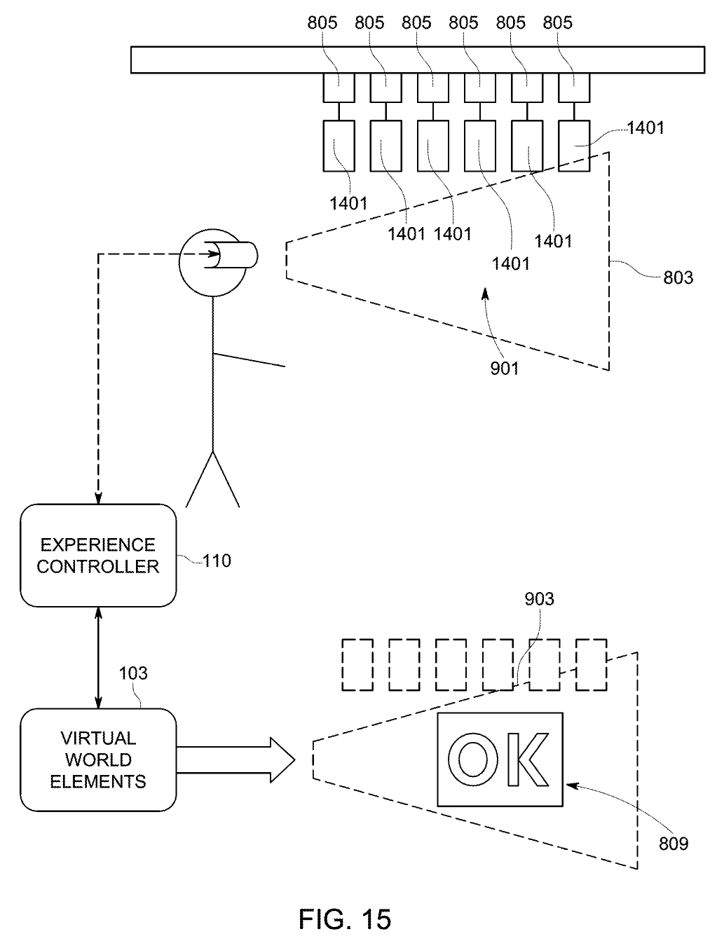

FIGS. 14-15 shows a schematic view of an exemplary embodiment of an experience platform system 100 according to the present disclosure shows a schematic view of an embodiment of the present disclosure showing a user 801 wearing an augmented reality interface system 102, which, in this embodiment, is an AR headset in an adaptive physical environment. The embodiment shown in FIG. 14 shows an embodiment of an experience platform system 100 where an AR headset is used to highlight scene elements 1401 that may or may not be otherwise visible to the user 801. As shown in FIG. 14, the augmented reality interface system 102 allows a view area 803 for user 801. While the view area 803 may otherwise allow visibility of the scene elements 1401, the vision may be obstructed by low lighting, fog effects or other conditions that might obstruct the view. However, as shown in FIG. 14, the virtual view 903 and the AR content 809 may include indicia of what might be obscured or a warning of what might be dangerous or prevent movement and may be displayed to the user 801. As shown in FIG. 15, the virtual view 903 and the AR content 809 may include indicia to the user 801 that the passage is not blocked and the user 801 may be free to pass. For example, scene elements 1401 may be in a position that may obstruct the movement of the user 801 and the user 801 may not be able to otherwise see the scene elements 1401 clearly due to lighting or obscured views. Indicia that it is okay to pass may be displayed to the user 801 when the path is no longer blocked. The AR content 809 is stored as virtual world elements 103 and are determined from either stored locations or physical world elements 101, such as, location, position or velocity sensors. The locations and indicia are saved in as virtual world elements 103 and are provided to the experience controller 110, where the locations and indicia are integrated and provided to the AR headset to display to the user.

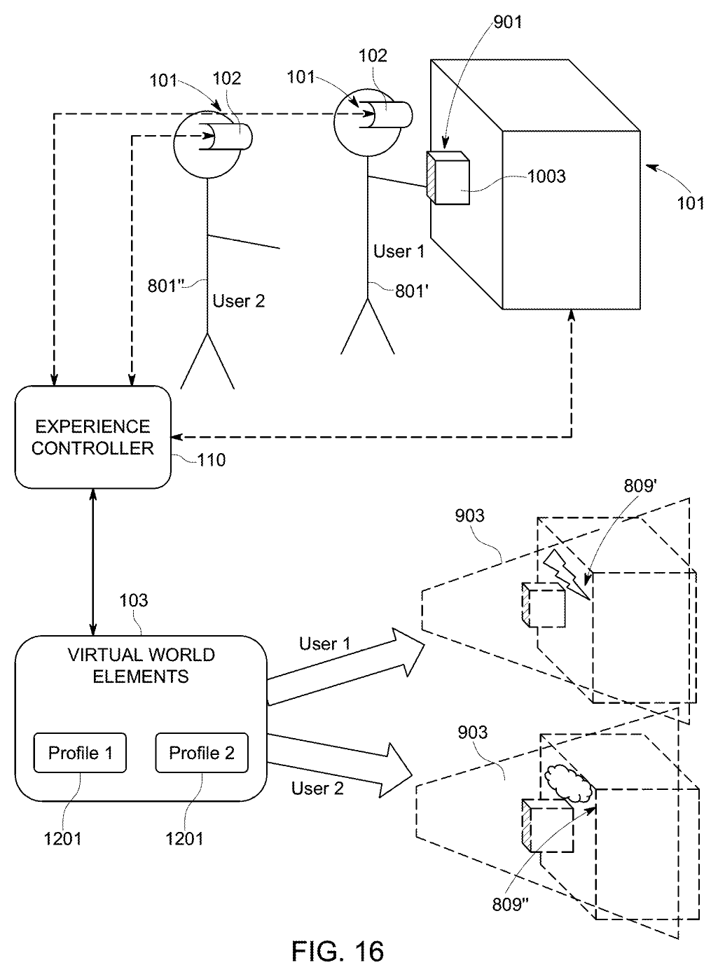

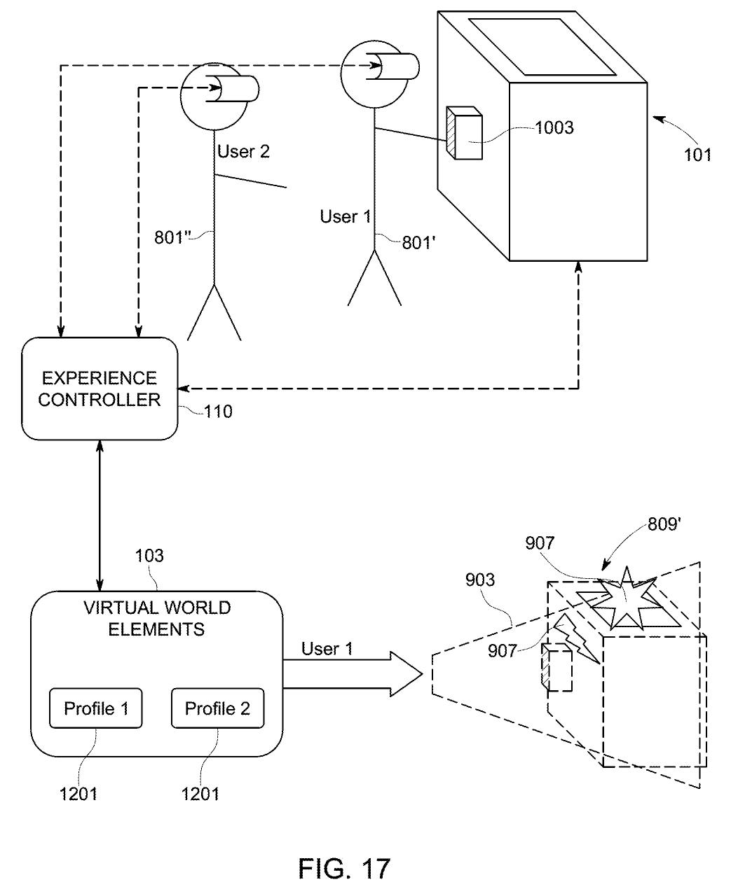

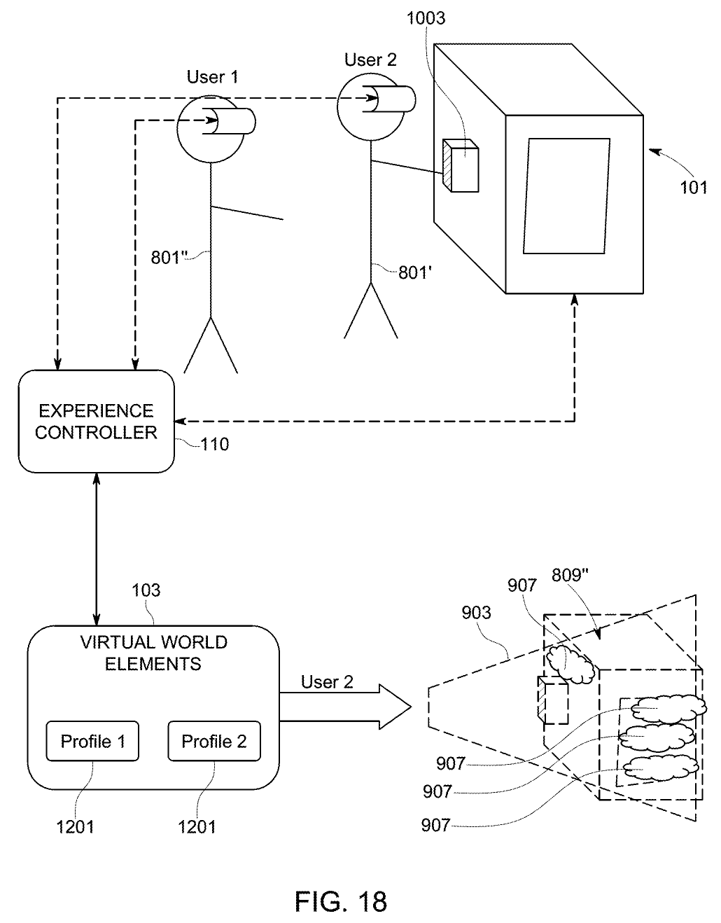

FIGS. 16-18 show an embodiment of an experience platform system 100 according to the present disclosure shows a schematic view of an embodiment of the present disclosure showing a plurality of users 801', 801" wearing an augmented reality interface system 102, which, in this embodiment, is an AR headset in an adaptive physical environment. The operation of this embodiment is similar to the systems shown and described above in FIGS. 8 and 10, where the users 801', 801" interact with an interactive element 1003. The AR headset tracks the user location 1101 and interactions with objects to dynamically change the behavior of the environment. As shown in FIGS. 16-18, a first user 801' sees a first AR content 809' and second user 801" sees a second AR content 809". Each of the AR contents 809',809" corresponds to a profile 1201, which likewise corresponds to a user 801',801". When the first user 801' interacts with interactive element 1003, a physical world element 101 reacts in a customize manner for user 801'. Likewise, when second user 801" interacts with interactive element 1003, a physical world element 101 reacts in a customize manner for user 801", which is different than for user 801'. Likewise, AR content 809' is not the same as AR content 809" and corresponds to user 801' or user 801". For instance in other embodiments, if a user pulls a lever, it opens a door. If a second user pulls the same lever, it turns on lights. Specific instructions and content are displayed on the headset display around the lever. Instruction and content are generated from the programmed user quest/journey. Once the lever has been pulled, the user quest state is updated, and the user is invited to resolve the next challenge.

Other features and advantages of the present invention will be apparent from the following more detailed description of the preferred embodiment, taken in conjunction with the accompanying drawings which illustrate, by way of example, the principles of the invention.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re- sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. An experience platform system comprising:
a physical world element, the physical world element comprising:
an augmented reality interface system;
a virtual world element; and
an experience controller integrating the physical world element and the virtual world element;
wherein the integrating includes real-time control of one or both of the physical world element and the virtual world element.

2. The experience platform system of claim 1, wherein the augmented reality interface system includes bi-directional augmented reality.

3. The experience platform system of claim 1, wherein the augmented reality interface system is an AR headset.

4. The experience platform system of claim 3, wherein the augmented reality interface system includes one or more position sensors.

5. The experience platform system of claim 3, wherein the augmented reality interface system includes an input/interaction device.

6. The experience platform system of claim 3, wherein the augmented reality interface system includes wireless headset interface.

7. The experience platform system of claim 1, wherein the virtual world element includes a profile corresponding to a user.

8. The experience platform system of claim 1, wherein the augmented reality interface system provides a real-time position corresponding to a user to the experience controller.

9. The experience platform system of claim 8, wherein a real-time position corresponding to one or more objects are provided to the experience controller.

10. The experience platform system of claim 9, wherein the experience controller provide control of one or more physical world elements in response to one or more of the real-time position corresponding to a user and the real-time position corresponding to one or more objects.

11. The experience platform system of claim 1, wherein the augmented reality interface system displays AR content to a first user.

12. The experience platform system of claim 11, wherein the augmented reality interface system displays AR content to a second user, wherein the AR content is not the same as the AR content displayed to the first user.

13. The experience platform system of claim 1, further comprising a physical world element having an interactive element.

14. The experience platform system of claim 13, wherein the interactive element includes corresponding AR content.

15. The experience platform system of claim 13, wherein the interactive element includes corresponding AR content corresponding to first user.

16. The experience platform system of claim 15, wherein the interactive element includes corresponding AR content corresponding to second user that is different than the AR content corresponding to the first user.

17. The experience platform system of claim 13, wherein interaction with the interactive component by a user results in the experience controller providing control of a physical world element.

18. The experience platform system of claim 13, wherein interaction with the interactive component by a first user results in the experience controller providing control of a physical world element corresponding to the first user.

19. The experience platform system of claim 18, wherein interaction with the interactive component by a second user results in the experience controller providing control of a physical world element corresponding to the second user that is different than the first user.
